(19) United States
(12) Patent Application Publication
(10) Pub. No.: US 2015/0228274 A1
(43) Pub. Date: Aug. 13, 2015

(54) Multi-Device Speech Recognition

(71) Applicant: NOKIA CORPORATION, Espoo (FI)

(72) Inventors: Tapani Antero Leppänen, Tampere (FI); Timo Tapani Aaltonen, Tampere (FI); Kimmo Kalervo Kuusilinna, Tampere (FI)

(73) Assignee: Nokia Technologies Oy, Espoo (FI)

(21) Appl. No.: 14/428,820

(22) PCT Filed: Oct. 26, 2012
(86) PCT No.: PCT/FI2012/051031

§ 371 Date: Mar. 17, 2015

(51) Int. Cl. G10L 15/06; G10L 15/28

(52) U.S. Cl. CPC G10L 15/06; G10L 15/28

(57) ABSTRACT

One or more devices in physical proximity of a user of a principal device are identified. Multiple audio samples captured by the identified devices are received. An audio sample comprising a voice of the user of the principal device is selected from among the multiple audio samples captured by the identified devices based on suitability of the audio sample for speech recognition.

### BACKGROUND

Many modern devices support speech recognition. A significant limiting factor in utilizing speech recognition is the quality of the audio sample. Among the factors that contribute to low or diminished quality audio samples are background noise and movement of the speaker in relation to the audio capturing device.

One approach to improving the quality of an audio sample is to utilize an array of microphones. Often, however, a microphone array will need to be calibrated to a specific setting before it can be effectively utilized. Such a microphone array is not well suited for a user that frequently moves from one setting to another.

### SUMMARY

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

In some embodiments, one or more secondary devices in physical proximity to a user of a principal device may be identified. Each of the secondary devices may be configured to capture audio. Multiple audio samples captured by the identified devices may be received. An audio sample comprising a voice of the user of the principal device may be selected from among the audio samples captured by the secondary devices based on suitability of the audio sample for speech recognition.

In some embodiments, the audio samples may be converted, via speech recognition, to corresponding text strings. Recognition confidence values corresponding to a level of confidence that a corresponding text string accurately reflects content of the audio sample from which it was converted may be determined. A recognition confidence value indicating a level of confidence as great or greater than the determined recognition confidence values may be identified, and an audio sample corresponding to the identified recognition confidence value may be selected. Additionally or alternatively, the audio samples may be analyzed to identify an audio sample that is equally well suited or more well suited for speech recognition and the identified audio sample may be selected.

In some embodiments, the audio samples captured by the secondary devices may include an audio sample comprising a voice other than the voice of the user of the principal device. The audio sample comprising the voice other than the voice of the user of the principal device may be identified by comparing each of the audio samples captured by the secondary devices to a reference audio sample of the voice of the user of the principal device. Once identified, the audio sample comprising the voice other than the voice of the user of the principal device may be discarded. Additionally or alternatively, the audio samples captured by the secondary devices may include an audio sample comprising both the voice of the user of the principal device and a voice other than the voice of the user of the principal device. The audio sample comprising both the voice of the user of the principal device and the voice other than the voice of the user of the principal device may be separated into two portions by comparing the audio sample comprising both the voice of the user of the principal device and the voice other than the voice of the user of the principal device to a reference audio sample of the voice of the user of the principal device. The first portion may comprise the voice of the user of the principal device and the second portion may comprise the voice of the user other than the user of the principal device. The second portion may be discarded.

### BRIEF DESCRIPTION OF THE DRAWINGS

The foregoing summary, as well as the following detailed description of illustrative embodiments, may be better understood when read in conjunction with the accompanying drawings, which are included by way of example, and not by way of limitation.

FIG. 1 illustrates an exemplary environment for multi-device speech recognition in accordance with one or more embodiments.

FIG. 2 illustrates an exemplary sequence for multi-device speech recognition in accordance with one or more embodiments.

FIG. 3 illustrates an exemplary method for selecting an audio sample based on a confidence level that a text string converted from the audio sample accurately reflects the content of the audio sample.

FIG. 4 illustrates an exemplary method for selecting an audio sample based on analyzing the suitability of the audio sample for speech recognition.

FIG. 5 illustrates an exemplary method for selecting an audio sample by dividing corresponding audio samples into multiple frames, selecting preferred frames based on their suitability for speech recognition, and combining the preferred frames to form a hybrid sample.

FIG. 6 illustrates an exemplary apparatus for multi-device speech recognition in accordance with one or more embodiments.

FIG. 7 illustrates an exemplary method for multi-device speech recognition.

### DETAILED DESCRIPTION

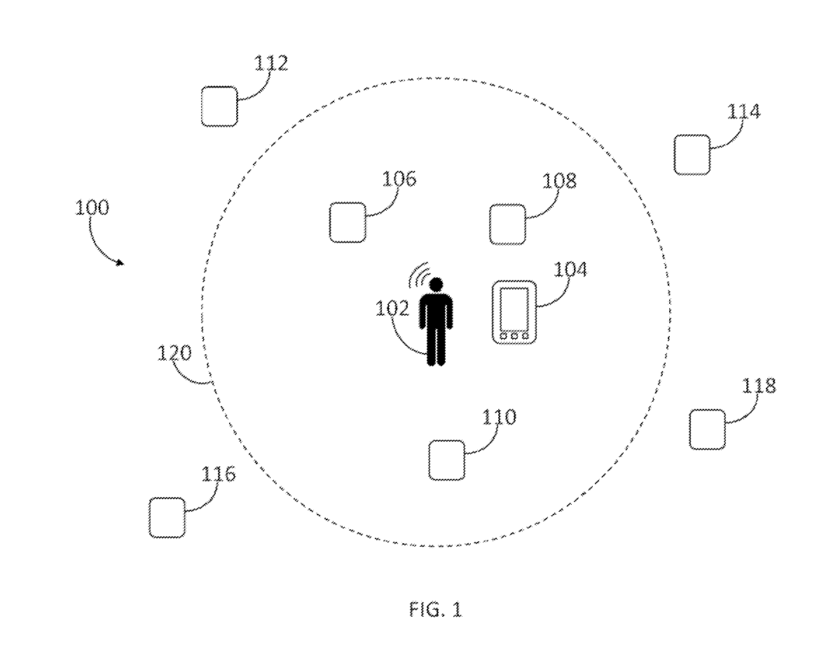

FIG. 1 illustrates an exemplary environment for multi-device speech recognition in accordance with one or more embodiments. Referring to FIG. 1, environment 100 may include user 102 and principal device 104. Principal device 104 may be any device capable of utilizing a text string produced via speech recognition. For example, principal device 104 may be a smartphone, tablet computer, laptop computer, desktop computer, or other similar device capable of utilizing a text string produced via speech recognition. Environment 100 may also include secondary devices 106-118. Secondary devices 106 -118 may include one or more devices capable of capturing audio associated with a user of principal device 104 (e.g., user 102). For example, secondary devices 106-118 may include smartphones, tablet computers, laptop computers, desktop computers, speakerphones, headsets, microphones integrated into a room or vehicle, or any other device capable of capturing audio associated with a user of principal device 104. As used herein, “principal device” refers to a device that utilizes output produced from an audio sample (e.g., a text string produced via speech recognition), and “secondary device” refers to any device, other than the principal device, that is capable of capturing audio associated with a user of the principal device. A principal device or a secondary device may also optionally perform one or more other functions as described herein.

As indicated above, a significant limiting factor in utilizing speech recognition is the quality of the audio sample utilized. The quality of the audio sample may be affected, for example, by background noise and the position of the speaker relative to the position of the device capturing the audio sample. For example, given the proximity of secondary device 106 to user 102, an audio sample captured by secondary device 106 may be of higher quality than an audio sample captured by secondary device 118.

According to certain embodiments, there may be an increase in the probability that a high quality audio sample will be available for speech recognition by utilizing multiple devices in physical proximity to the user to capture multiple audio samples. First, one or more secondary devices in physical proximity to a user of a principal device may be identified. For example, secondary devices 106, 108, and 110 may be identified as located within a physical proximity 120 of principal device 104 or user 102. Each of the identified secondary devices may be configured to capture audio. Next, an audio sample comprising a voice of the user of the principal device may be selected from among a plurality of audio samples captured by the identified secondary devices based on suitability of the audio sample for speech recognition. For example, an audio sample comprising the voice of user 102, which was captured by secondary device 106, may be selected from among audio samples captured by secondary devices 106, 108, and 110 based on its suitability for speech recognition. The selection may occur at a central server, at principal device 104, or some other location.

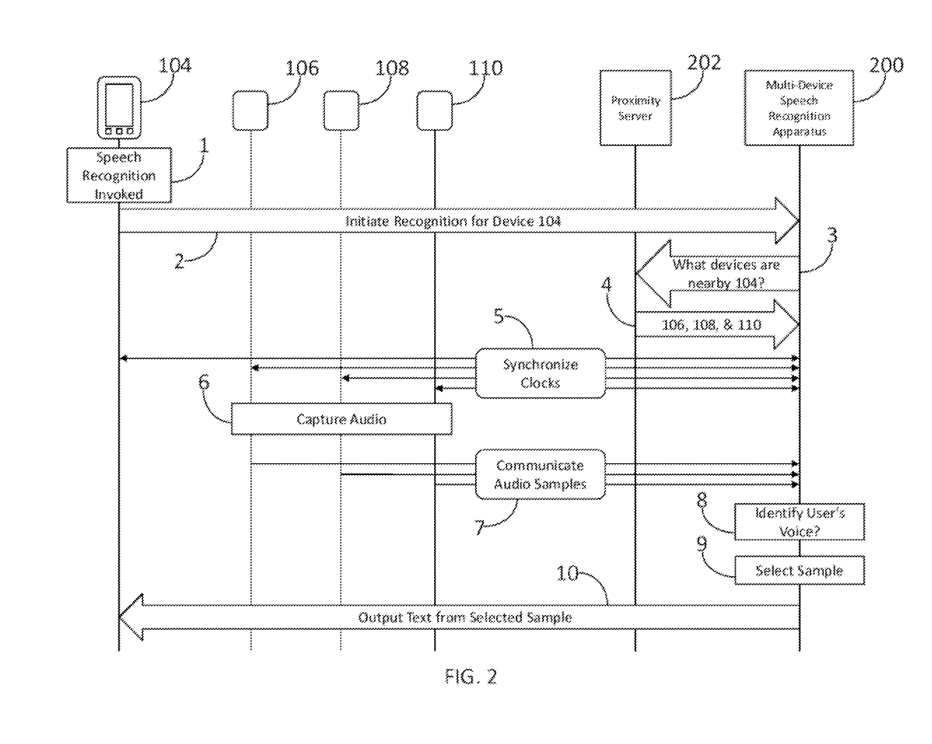

FIG. 2 illustrates an exemplary sequence for multi-device speech recognition in accordance with one or more embodiments. Referring to FIG. 2, at step 1, speech recognition may be invoked on principal device 104. For example, user 102 may invoke speech recognition on principal device 104 by pressing a button associated with principal device 104, selecting a portion of a touch screen associated with principal device 104, or speaking an activation word associated with principal device 104. Additionally or alternatively, speech recognition may be invoked based on principal device 104 being held by user 102 (e.g., utilizing sensor data, such as that from an accelerometer or proximity sensor), contemporaneous utilization of principal device 104, user 102 being logged into principal device 104, or based on principal device 104 detecting that user 102 is looking at it (e.g., utilizing a camera associated with principal device 104 that is configured to track the eyes of user 102). At step 2, principal device 104 may send a message to multi-device speech recognition apparatus 200 indicating that multi-device speech recognition should be initiated for principal device 104. In some embodiments, multi-device speech recognition apparatus 200 may be a computing device distinct from principal device 104 (e.g., a server). In other embodiments, multi-device speech recognition apparatus 200 may be a component of principal device 104.

In response to multi-device speech recognition being initiated for principal device 104, multi-device speech recognition apparatus 200 may begin the process of identifying one or more secondary devices in proximity to user 102 or principal device 104. For example, at step 3, multi-device speech recognition apparatus 200 may send a request to proximity server 202 inquiring as to which, if any, secondary devices are located in proximity to principal device 104. Proximity server 202 may maintain proximity information for a predetermined set of devices (e.g., principal device 104 and secondary devices 106-118). For example, proximity server 202 may periodically receive current location information from each of a predetermined set of devices. In order to identify secondary devices located in physical proximity of principal device 104, proximity server 202 may compare current location information for principal device 104 to current location information for each of the predetermined set of devices. In some embodiments, the predetermined set of devices may be limited to a list of devices specified by user 102 (e.g., user 102's devices) or devices associated with users specified by user 102 (e.g., devices associated with user 102's family members or coworkers). Alternatively, principal device 104 may determine what other devices are nearby through such means as BLUETOOTH, infrared, Wi-Fi, or other communication technologies.

At step 4, proximity server 202 may respond to multi-device speech recognition apparatus 200's request with a response indicating that secondary devices 106, 108, and 110 are located in proximity to principal device 104. At step 5, multi-device speech recognition apparatus 200 may communicate with principal device 104 and secondary devices 106, 108, and 110 in order to synchronize their respective clocks, or to get simultaneous timestamps from these devices to determine timing offsets. As will be described in greater detail below, audio samples captured by principal device 104 and secondary devices 106, 108, and 110 may be timestamped, and thus it may be advantageous to synchronize their respective clocks.

At step 6, secondary devices 106, 108, and 110 may each capture one or more audio samples using built-in microphones, and, at step 7, may communicate the captured audio samples to multi-device speech recognition apparatus 200. For example, the audio samples may be communicated via one or more network connections (e.g., a cellular network, a Wi-Fi network, a BLUETOOTH network, or the Internet). In some embodiments, secondary devices 106, 108, and 110 may be configured to capture audio samples in response to a specific communication from multi-device speech recognition apparatus 200 (e.g., a message indicating that multi-device speech recognition has been initiated for principal device 104). In other embodiments, secondary devices 106, 108, and 110 may be configured to continuously capture audio samples, and these continuously captured audio samples may be mined or queried to identify one or more audio samples being requested by multi-device speech recognition apparatus 200 (e.g., one or more audio samples corresponding to a time period for which multi-device speech recognition has been initiated). Additionally or alternatively, one or more of secondary devices 106, 108, and 110 may be configured to capture audio in response to detecting the voice of user 102. In such embodiments, each of secondary devices 106, 108, and 110 may be triggered to capture audio in response to one or more of secondary devices 106, 108, or 110 detecting the voice of user 102.

Secondary devices 106, 108, and 110 may be further configured to stop capturing audio in response to user 102 indicating the end of an utterance or in response to one or more of secondary devices 106, 108, or 110 detecting the end of an utterance. In some embodiments, a camera sensor associated with one or more of secondary devices 106, 108, or 110 may be utilized to trigger or stop the capture of audio based on detecting user 102's lip movements or facial expressions. In some embodiments, secondary devices 106, 108, and 110 may each be configured to capture audio samples using the same sampling rate. In other embodiments, secondary devices 106, 108, and 110 may capture audio samples using different sampling rates. It will be appreciated that in addition to the audio samples captured by one or more of secondary devices 106, 108, and 110, primary device 104 may also capture one or more audio samples, which may be communicated to multi-device speech recognition apparatus 200, and, as will be described in greater detail below, may be utilized by multi-device speech recognition apparatus 200 in selecting an audio sample based on suitability for speech recognition.

At step 8, multi-device speech recognition apparatus 200 may identify a voice associated with user 102 within one or more of the audio samples received from secondary devices 106, 108, and 110. For example, one or more of the audio samples received from secondary devices 106, 108, and 110 may include a voice other than the voice of user 102 and multi-device speech recognition apparatus 200 may be configured to compare the received audio samples to a reference audio sample of the voice of user 102 to identify such an audio sample. Once identified, such an audio sample may be discarded, for example, to protect the privacy of the extraneous voice's speaker. Similarly, one or more of the audio samples received from secondary devices 106, 108, and 110 may include both a voice of user 102 and a voice other than the voice of user 102. Multi-device speech recognition apparatus 200 may be configured to compare the received audio samples to a reference audio sample of the voice of user 102 to identify such an audio sample. Once identified, such an audio sample may be separated into two portions, a portion comprising the voice of user 102 and a portion comprising the voice of the user other than the voice of user 102. The portion comprising the voice of the user other than the voice of user 102 may then be discarded, for example, to protect the privacy of the extraneous voice's speaker.

As will be described in greater detail below, at step 9, multi-device speech recognition apparatus 200 may select an audio sample from among the audio samples received from secondary devices 106, 108, and 110 based on its suitability for speech recognition and, at step 10, a text string produced by performing speech recognition on the selected audio sample may optionally be communicated to principal device 104.

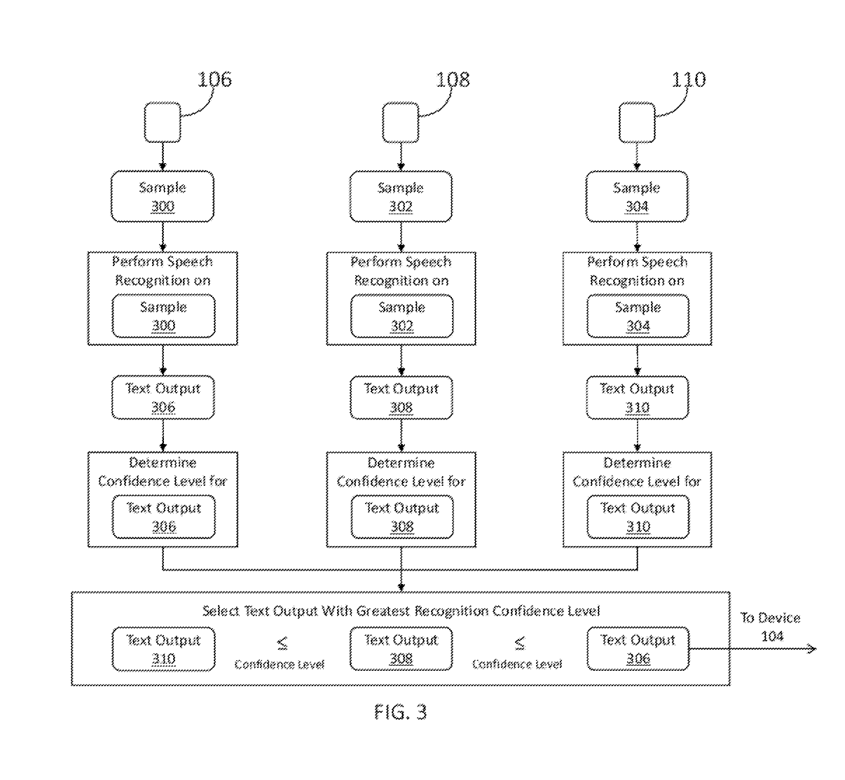

FIG. 3 illustrates an exemplary method for selecting an audio sample based on a confidence level that a text string converted from the audio sample accurately reflects the content of the audio sample. Referring to FIG. 3, an audio sample may be received from each of secondary devices 106, 108, and 110. For example, audio samples 300, 302, and 304 may respectively be received from secondary devices 106, 108, and 110. As indicated above, secondary devices 106, 108, and 110 may each be configured to respectively timestamp audio samples 300, 302, and 304 as they are captured. Multi-device speech recognition apparatus 200 may utilize these timestamps to identify audio samples corresponding to common periods of time. For example, audio samples 300, 302, and 304 may each correspond to a common period of time during which user 102 was speaking. In some embodiments, the size of samples 300, 302, and 304 may be dynamic. For example, the size of samples 300, 302, and 304 may be adjusted so that samples 300, 302, and 304 each comprise a single complete utterance of user 102.

Multi-device speech recognition apparatus 200 may be configured to perform speech recognition on each of samples 300, 302, and 304, respectively generating corresponding text string outputs 306, 308, and 310. A recognition confidence value corresponding to a confidence level that the corresponding text strings accurately reflect the content of the audio samples from which they were generated may then be determined for each of text string outputs 306, 308, and 310. Audio samples 300, 302, and 304, or their respective text string outputs 306, 308, and 310 may be ordered based on their respective recognition confidence values, and the audio sample or text string output corresponding to the greatest confidence level may be selected. For example, due to secondary device 106's close proximity to user 102, the audio sample captured by secondary device 106 may be of higher quality than those captured by secondary devices 108 and 110, and thus the recognition confidence value for text string output 306 may be greater than the recognition confidence values for text string outputs 308 and 310, and text string output 306 may be selected and communicated to primary device 104.

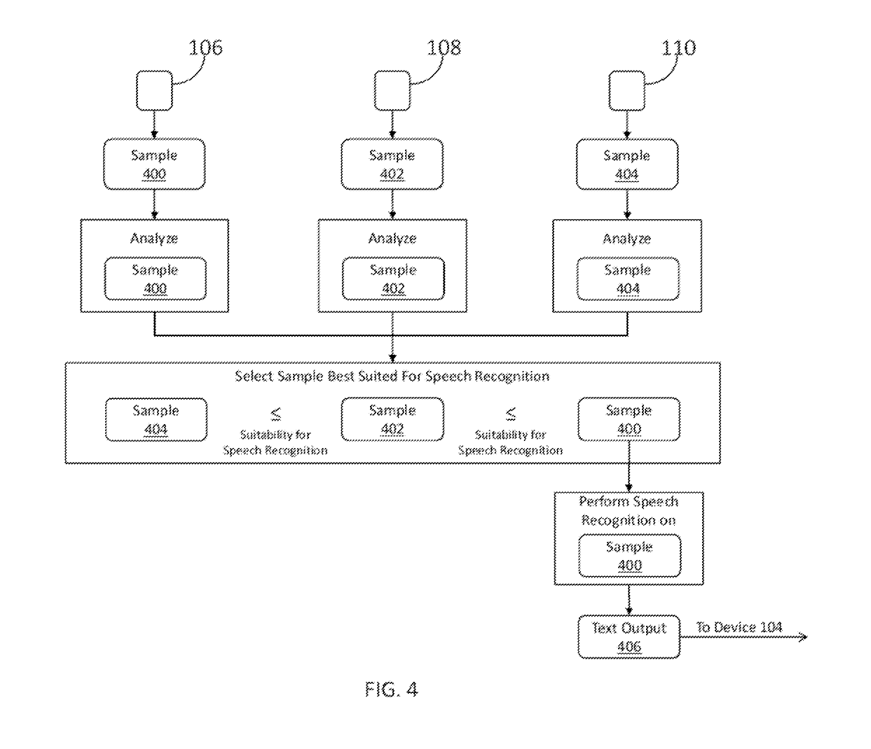

FIG. 4 illustrates an exemplary method for selecting an audio sample based on analyzing the suitability of the audio sample for speech recognition. Referring to FIG. 4, audio samples 400, 402, and 404 may respectively be received from secondary devices 106, 108, and 110. As indicated above, secondary devices 106, 108, and 110 may each be configured to respectively timestamp audio samples 400, 402, and 404 as they are captured. Multi-device speech recognition apparatus 200 may utilize these timestamps to identify audio samples corresponding to common periods of time. For example, audio samples 400, 402, and 404 may each correspond to a common period of time during which user 102 was speaking. In some embodiments, this time period may correspond to an utterance by user 102. For example, the time period may begin when user 102 starts speaking and end when user 102 completes an utterance or sentence. Similarly, an additional time period, corresponding to one or more additional audio samples, may begin when user 102 initiates a new utterance or sentence.

Multi-device speech recognition apparatus 200 may be configured to analyze each of audio samples 400, 402, and 404 to determine their suitability for speech recognition. For example, multi-device speech recognition apparatus 200 may determine one or more of a signal-to-noise ratio, an amplitude level, a gain level, or a phoneme recognition level for each of audio samples 400, 402, and 404. Audio samples 400, 402, and 404 may then be ordered based on their suitability for speech recognition.

For example, an audio sample having a signal-to-noise ratio indicating a higher proportion of signal-to-noise may be considered more suitable for speech recognition. Similarly, an audio sample having a higher amplitude level may be considered more suitable for speech recognition; an audio sample associated with a secondary device having a lower gain level may be considered more suitable for speech recognition; or an audio sample having a higher phoneme recognition level may be considered more suitable for speech recognition. The audio sample determined to be best suited for speech recognition may then be selected. For example, due to secondary device 106's close proximity to user 102, audio sample 400 may be determined to be best suited for speech recognition (e.g., audio sample 400 may have a signal-to-noise ratio indicating a higher proportion of signal-to-noise than either of audio samples 402 or 404). Multi-device speech recognition apparatus 200 may utilize one or more known means to perform speech recognition on audio sample 400, generating output text string 406, which may be communicated to primary device 104.

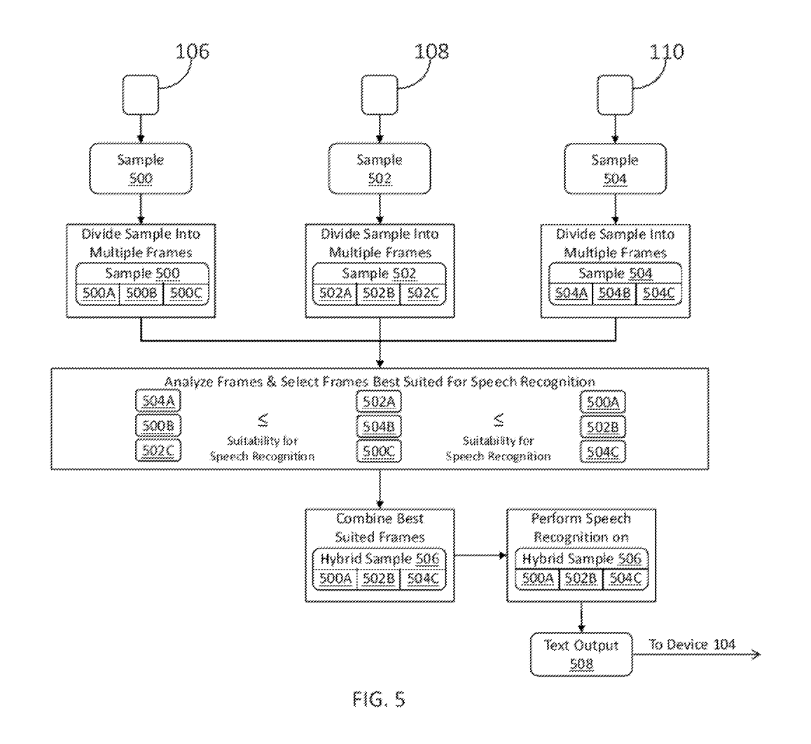

FIG. 5 illustrates an exemplary method for selecting an audio sample by dividing corresponding audio samples into multiple frames, selecting preferred frames based on their suitability for speech recognition, and combining the preferred frames to form a hybrid sample. Referring to FIG. 5, audio samples 500, 502, and 504 may respectively be received from secondary devices 106, 108, and 110. As indicated above, secondary devices 106, 108, and 110 may each be configured to respectively timestamp audio samples 500, 502, and 504 as they are captured. Multi-device speech recognition apparatus 200 may utilize the timestamps of audio samples 500, 502, and 504 to divide each of the samples into multiple frames, the frames corresponding to portions of time over which audio samples 500, 502, and 504 were captured. For example, audio sample 500 may be divided into frames 500A, 500B, and 500C. Similarly, audio sample 502 may be divided into frames 502A, 502B, and 502C; and audio sample 504 may be divided into frames 504A, 504B, and 504C. In some embodiments, the size of each frame may be fixed to a predefined length. In other embodiments, the size of each frame may be dynamic. For example, the frames may be sized so that they each comprise a single phoneme.

Multi-device speech recognition apparatus 200 may analyze each of the frames to identify a preferred frame for each portion of time based on their suitability for speech recognition (e.g., based on one or more of the frames' signal-to-noise ratios, amplitude levels, gain levels, or phoneme recognition levels). For example, for the period of time corresponding to frames 500A, 502A, and 504A, multi-device speech recognition apparatus 200 may determine that frame 500A is more suitable for speech recognition than frames 502A or 504A. Similarly, for the period of time corresponding to frames 500B, 502B, and 504B, multi-device speech recognition apparatus 200 may determine that frame 502B is more suitable for speech recognition than frames 504B or 500B; and for the period of time corresponding to frames 500C, 502C, and 504C, multi-device speech recognition apparatus 200 may determine that frame 504C is more suitable for speech recognition than frames 500C or 502C. The frames determined to be most suitable for speech recognition for their respective period of time may then be combined to form hybrid sample 506. Multi-device speech recognition apparatus 200 may then perform speech recognition on hybrid sample 506, generating output text string 508, which may be communicated to primary device 104.

It will be appreciated that by dividing each of audio samples 500, 502, and 504 into multiple frames corresponding to portions of time over which the audio samples were captured, selecting a preferred frame for each portion of time based on its suitability for speech recognition, and then combining the selected preferred frames to form hybrid sample 506, the probability that output text string 508 will accurately reflect the content of user 102's utterance may be increased. For example, while speaking the utterance captured by audio samples 500, 502, and 504, user 102 may have physically turned from facing secondary device 106, to facing secondary device 108, and then to facing secondary device 110. Thus, frame 500A may be more suitable for speech recognition for the portion of time user 102 was facing secondary device 106, frame 502B may be more suitable for speech recognition for the portion of time user 102 was facing secondary device 108, and frame 504C may be more suitable for speech recognition for the portion of time user 102 was facing secondary device 110.

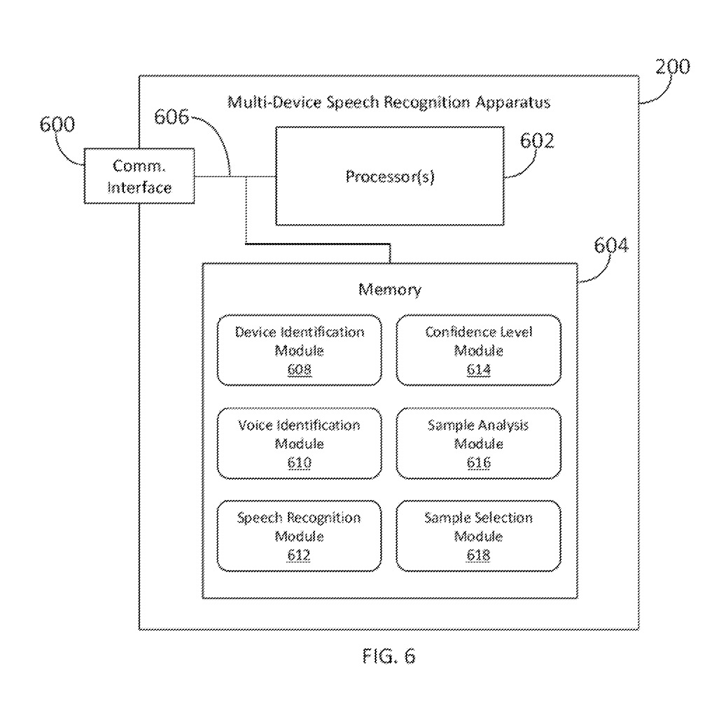

FIG. 6 illustrates an exemplary apparatus for multi-device speech recognition in accordance with one or more embodiments. Referring to FIG. 6, multi-device speech recognition apparatus 200 may include communication interface 600. Communication interface 600 may be any communication interface capable of receiving one or more audio samples from one or more secondary devices. For example, communication interface 600 may be a network interface (e.g., an Ethernet card, a wireless network interface, or a cellular network interface). Multi-device speech recognition apparatus 200 may also include a means for identifying one or more secondary devices in physical proximity to a user of a principal device, and a means for selecting an audio sample comprising a voice of the user of the principal device from among a plurality of audio samples captured by the one or more secondary devices based on the suitability of the audio sample for speech recognition. For example, multi-device speech recognition apparatus 200 may include one or more processors 602 and memory 604. Communication interface 600, processor(s) 602, and memory 604 may be interconnected via data bus 606.

Memory 604 may include one or more program modules comprising executable instructions that when executed by processor(s) 602 cause multi-device speech recognition apparatus 200 to perform one or more functions described herein. For example, memory 604 may include device identification module 608, which may comprise instructions configured to cause multi-device speech recognition apparatus 200 to identify a plurality of devices in physical proximity to a user of a principal device. Similarly, memory 604 may also include: voice identification module 610, which may comprise instructions configured to cause multi-device speech recognition apparatus 200 to identify a voice of user 102 within one or more audio samples captured by secondary devices; speech recognition module 612, which may comprise instructions configured to cause multi-device speech recognition apparatus 200 to convert one or more audio samples into one or more corresponding text output strings; confidence level module 614, which may comprise instructions configured to cause multi-device speech recognition apparatus 200 to determine a plurality of confidence levels indicating a level of confidence that a text string accurately reflects the content of an audio sample from which it was converted; sample analysis module 616, which may comprise instructions configured to cause multi-device speech recognition apparatus 200 to identify an audio sample based on its suitability for speech recognition; and sample selection module 618, which may comprise instructions configured to cause multi-device speech recognition apparatus 200 to select an audio sample based on its suitability for speech recognition.

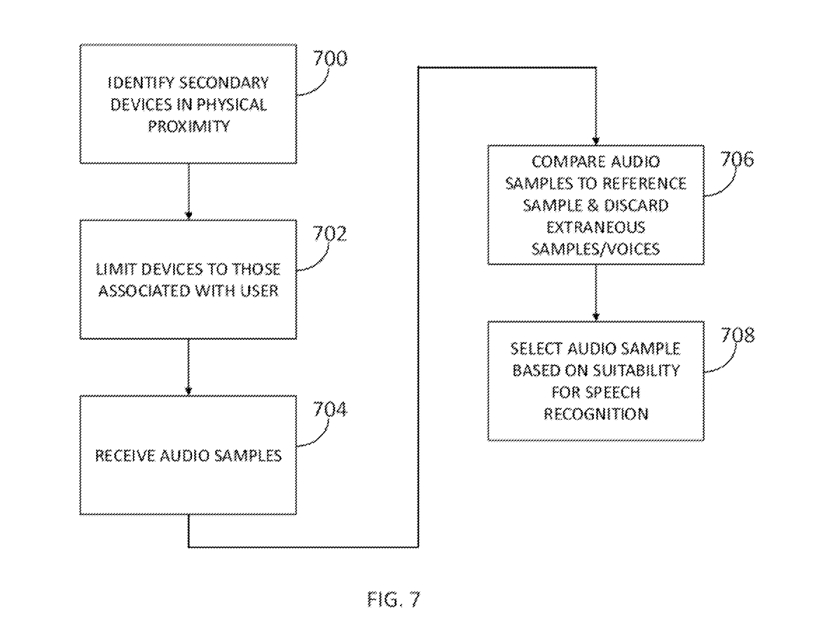

FIG. 7 illustrates an exemplary method for multi-device speech recognition. Referring to FIG. 7, in step 700 one or more secondary devices in physical proximity to a user of a principal device are identified. For example, secondary devices 106, 108, and 110 may be identified as being in physical proximity 120 of principal device 104's user 102. In step 702 the identified devices may be limited to a set of devices associated with user 102 (e.g., devices associated with user 102's family members or coworkers). In step 704, audio samples are received from the identified devices. For example, audio samples 400, 402, and 404 may respectively be received from secondary devices 106, 108, and 110. In step 706, the received audio samples may be compared to a reference sample of user 102's voice to identify samples or portions of samples that contain voices other than user 102's voice, and the extraneous samples (or extraneous portions of the samples) may be discarded. In step 708, an audio sample may be selected from among the audio samples based on its suitability for speech recognition. For example, multi-device speech recognition apparatus 200 may select audio sample 400, from among audio samples 400, 402, and 404, based on its suitability for speech recognition.

The methods and features recited herein may be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

Additionally or alternatively, in at least some embodiments, the methods and features recited herein may be implemented through one or more integrated circuits (ICs). An integrated circuit may, for example, be a microprocessor that accesses programming instructions or other data stored in a read only memory (ROM). In some embodiments, a ROM may store program instructions that cause an IC to perform operations according to one or more of the methods described herein. In some embodiments, one or more of the methods described herein may be hardwired into an IC. In other words, an IC may comprise an application specific integrated circuit (ASIC) having gates and other logic dedicated to the calculations and other operations described herein. In still other embodiments, an IC may perform some operations based on execution of programming instructions read from ROM or RAM, with other operations hardwired into gates or other logic. Further, an IC may be configured to output image data to a display buffer.

Although specific examples of carrying out the disclosure have been described, those skilled in the art will appreciate that there are numerous variations and permutations of the above-described apparatuses and methods that are contained within the spirit and scope of the disclosure as set forth in the appended claims. Additionally, numerous other embodiments, modifications, and variations within the scope and spirit of the appended claims may occur to persons of ordinary skill in the art from a review of this disclosure. Specifically, any of the features described herein may be combined with any or all of the other features described herein.

1-35. (canceled)

36. A method comprising:
identifying one or more secondary devices in physical proximity to a user of a principal device, each of the one or more secondary devices being configured to capture audio;
receiving a plurality of audio samples captured by the one or more secondary devices; and
selecting an audio sample comprising a voice of the user of the principal device from among the plurality of audio samples captured by the one or more secondary devices based on suitability of the audio sample for speech recognition.

37. The method of claim 36, wherein identifying the one or more secondary devices in physical proximity to the user of the principal device comprises:
receiving current location information from each of a predetermined set of secondary devices; and
identifying the one or more secondary devices in physical proximity to the user of the principal device by comparing the current location information received from each of the predetermined set of secondary devices with current location information for the principal device to determine which of the predetermined set of secondary devices are physically proximate to the principal device.

38. The method of claim 36, wherein selecting the audio sample comprising the voice of the user of the principal device comprises:
converting, via speech recognition, the plurality of audio samples into a plurality of corresponding text strings;
determining a plurality of recognition confidence values, each of the plurality of recognition confidence values corresponding to a level of confidence that a corresponding text string of the plurality of corresponding text strings accurately reflects content of an audio sample of the plurality of audio samples from which the corresponding text string was converted;
identifying, from among the plurality of recognition confidence values, a recognition confidence value indicating a level of confidence as great or greater than that of each of the plurality of recognition confidence values; and
selecting an audio sample of the plurality of audio samples that corresponds to the identified recognition confidence value indicating the level of confidence as great or greater than that of each of the plurality of recognition confidence values.

39. The method of claim 36, wherein selecting the audio sample comprising the voice of the user of the principal device during the period of time comprises:
analyzing the plurality of audio samples to identify an audio sample of the plurality of audio samples that is equally well suited or more well suited for speech recognition; and
selecting the identified audio sample of the plurality of audio samples that is equally well suited or more well suited for speech recognition.

40. The method of claim 39, wherein analyzing the plurality of audio samples to identify the audio sample of the plurality of audio samples that is equally well suited or more well suited for speech recognition comprises at least one of:
determining a plurality of signal-to-noise ratios, each of the plurality of signal-to-noise ratios corresponding to one of the plurality of audio samples, and wherein the audio sample of the plurality of audio samples that is equally well suited or more well suited for speech recognition corresponds to a signal-to-noise ratio of the plurality of signal-to-noise ratios that indicates a proportion of signal-to-noise that is as great or greater than each of the plurality of signal-to-noise ratios;
determining a plurality of amplitude levels, each of the plurality of amplitude levels corresponding to one of the plurality of audio samples, and wherein the audio sample of the plurality of audio samples that is equally well suited or more well suited for speech recognition corresponds to an amplitude level of the plurality of amplitude levels that is as great or greater than each of the plurality of amplitude levels;
determining a plurality of gain levels, each of the plurality of gain levels corresponding to one of the one or more secondary devices, and wherein the audio sample of the plurality of audio samples that is equally well suited or more well suited for speech recognition corresponds to a gain level of the plurality of gain levels that is as low or lower than each of the plurality of gain levels; and
determining a plurality of phoneme recognition levels, each of the plurality of phoneme recognition levels corresponding to one of the plurality of audio samples, and wherein the audio sample of the plurality of audio samples that is equally well suited or more well suited for speech recognition corresponds to a phoneme recognition level of the plurality of phoneme recognition levels that indicates a phoneme recognition level as great or greater than each of the plurality of phoneme recognition levels.

41. The method of claim 36, wherein the plurality of audio samples captured by the one or more secondary devices includes at least one audio sample comprising a voice other than the voice of the user of the principal device, the method further comprising identifying the at least one audio sample comprising the voice other than the voice of the user of the principal device by comparing each of the plurality of audio samples to a reference audio sample of the voice of the user of the principal device.

42. The method of claim 36, wherein the plurality of audio samples captured by the one or more secondary devices includes at least one audio sample comprising both the voice of the user of the principal device and a voice other than the voice of the user of the principal device, the method further comprising separating the at least one audio sample comprising both the voice of the user of the principal device and the voice other than the voice of the user of the principal device into a first portion and a second portion by comparing the at least one audio sample comprising both the voice of the user of the principal device and the voice other than the voice of the user of the principal device to a reference audio sample of the voice of the user of the principal device, the first portion comprising the voice of the user of the principal device, and the second portion comprising the voice other than the voice of the user of the principal device.

43. The method of claim 36, wherein selecting the audio sample comprising the voice of the user of the principal device comprises:
dividing each of the plurality of audio samples captured by the one or more secondary devices into a plurality of frames;
selecting, from among the plurality of frames, a plurality of preferred frames, each of the plurality of preferred frames corresponding to a portion of time over which the plurality of audio samples captured by the one or more secondary devices were captured, and each of the plurality of preferred frames being equally well suited or more well suited for speech recognition than any of the plurality of frames that correspond to the portion of time over which the plurality of audio samples captured by the one or more secondary devices were captured; and
combining each of the plurality of preferred frames to form the audio sample comprising the voice of the user of the principal device.

44. The method of claim 43, wherein each of the plurality of frames contains at least one of:
a predefined length; and
a single phoneme.

45. The method of claim 43, wherein the plurality of preferred frames comprises a first frame from a first of the plurality of audio samples and a second frame from a second of the plurality of audio samples, the second of the plurality of audio samples being a different audio sample from the first of the plurality of audio samples.

46. The method of claim 36, wherein the one or more secondary devices are configured to continuously capture audio, and wherein the plurality of audio samples captured by the one or more secondary devices correspond to portions of the continuously captured audio identified as corresponding to a common period of time.

47. The method of claim 36, wherein the one or more secondary devices are configured to capture audio in response to at least one of the one or more secondary devices detecting the voice of the user of the principal device.

48. An apparatus comprising:
at least one processor; and
a memory storing instructions that when executed by the at least one processor cause the apparatus to:
identify one or more secondary devices in physical proximity to a user of a principal device, each of the one or more secondary devices being configured to capture audio;
receive a plurality of audio samples captured by the one or more secondary devices; and
select an audio sample comprising a voice of the user of the principal device from among the plurality of audio samples captured by the one or more secondary devices based on suitability of the audio sample for speech recognition.

49. The apparatus of claim 48, the memory storing instructions that when executed by the at least one processor cause the apparatus to:
convert, via speech recognition, the plurality of audio samples into a plurality of corresponding text strings;
determine a plurality of recognition confidence values, each of the plurality of recognition confidence values corresponding to a level of confidence that a corresponding text string of the plurality of corresponding text strings accurately reflects content of an audio sample of the plurality of audio samples from which the corresponding text string was converted;
identify, from among the plurality of recognition confidence values, a recognition confidence value indicating a level of confidence as great or greater than that of each of the plurality of recognition confidence values; and
select an audio sample of the plurality of audio samples that corresponds to the identified recognition confidence value indicating the level of confidence as great or greater than that of each of the plurality of recognition confidence values.

50. The apparatus of claim 48, the memory storing instructions that when executed by the at least one processor cause the apparatus to:
analyze the plurality of audio samples to identify an audio sample of the plurality of audio samples that is equally well suited or more well suited for speech recognition; and
select an identified audio sample of the plurality of audio samples that is equally well suited or more well suited for speech recognition.

51. The apparatus of claim 50, the memory storing instructions that when executed by the at least one processor cause the apparatus to at least one of:
determine a plurality of signal-to-noise ratios, each of the plurality of signal-to-noise ratios corresponding to one of the plurality of audio samples, and wherein the audio sample of the plurality of audio samples that is equally well suited or more well suited for speech recognition corresponds to a signal-to-noise ratio of the plurality of signal-to-noise ratios that indicates a proportion of signal-to-noise that is as great or greater than each of the plurality of signal-to-noise ratios;
determine a plurality of amplitude levels, each of the plurality of amplitude levels corresponding to one of the plurality of audio samples, and wherein the audio sample of the plurality of audio samples that is equally well suited or more well suited for speech recognition corresponds to an amplitude level of the plurality of amplitude levels that is as great or greater than each of the plurality of amplitude levels;
determine a plurality of gain levels, each of the plurality of gain levels corresponding to one of the one or more secondary devices, and wherein the audio sample of the plurality of audio samples that is equally well suited or more well suited for speech recognition corresponds to a gain level of the plurality of gain levels that is as low or lower than each of the plurality of gain levels; and
determine a plurality of phoneme recognition levels, each of the plurality of phoneme recognition levels corresponding to one of the plurality of audio samples, and wherein the audio sample of the plurality of audio samples that is equally well suited or more well suited for speech recognition corresponds to a phoneme recognition level of the plurality of phoneme recognition levels that indicates a phoneme recognition level as great or greater than each of the plurality of phoneme recognition levels.

52. The apparatus of claim 48, wherein the plurality of audio samples captured by the one or more secondary devices includes at least one audio sample comprising a voice other than the voice of the user of the principal device, the memory storing instructions that when executed by the at least one processor cause the apparatus to:
identify the at least one audio sample comprising the voice other than the voice of the user of the principal device by comparing each of the plurality of audio samples to a reference audio sample of the voice of the user of the principal device; and
discard the at least one audio sample comprising the voice other than the voice of the user of the principal device.

53. The apparatus of claim 48, wherein the plurality of audio samples captured by the one or more secondary devices includes at least one audio sample comprising both the voice of the user of the principal device and a voice other than the voice of the user of the principal device, the memory storing instructions that when executed by the at least one processor cause the apparatus to:
separate the at least one audio sample comprising both the voice of the user of the principal device and the voice other than the voice of the user of the principal device into a first portion and a second portion by comparing the at least one audio sample comprising both the voice of the user of the principal device and the voice other than the voice of the user of the principal device to a reference audio sample of the voice of the user of the principal device, the first portion comprising the voice of the user of the principal device, and the second portion comprising the voice other than the voice of the user of the principal device; and
discard the second portion comprising the voice other than the voice of the user of the principal device.

54. The apparatus of claim 48, the memory storing instructions that when executed by the at least one processor cause the apparatus to:
divide each of the plurality of audio samples captured by the one or more secondary devices into a plurality of frames;
select, from among the plurality of frames, a plurality of preferred frames, each of the plurality of preferred frames corresponding to a portion of time over which the plurality of audio samples captured by the one or more secondary devices were captured, and each of the plurality of preferred frames being equally well suited or more well suited for speech recognition than any of the plurality of frames that correspond to the portion of time over which the plurality of audio samples captured by the one or more secondary devices were captured; and
combine each of the plurality of preferred frames to form the audio sample comprising the voice of the user of the principal device.

55. The apparatus of claim 54, wherein the plurality of preferred frames comprises a first frame from a first of the plurality of audio samples and a second frame from a second of the plurality of audio samples, the second of the plurality of audio samples being a different audio sample from the first of the plurality of audio samples.
